(19) United States
(12) Patent Application Publication
(10) Pub. No.: US 2005/0185274 A1
(43) Pub. Date: Aug. 25, 2005

(54) Method and arrangement for stereoscopic viewing

(76) Inventors: Karl-Heinz Geier, Jena (DE); Hans Tandler, Jena (DE)

Correspondence Address: Walter Ottesen;Patent Attorney, P.O. Box 4026, Gaithersburg, MD, 20885-4026, US

(21) Appl. No.: 11/078,289

(22) Filed: Mar. 14, 2005

Related U.S. Application Data
(63) Continuation-in-part of application No. 10/075,456, filed on Feb. 15, 2002, now Pat. No. 6,882,473.
Application No. 10/075,456 is a continuation-in-part of application No. 09/505,724, filed on Feb. 17, 2000, now Pat. No. 6,348,994.
Application No. 09/505,724 is a continuation of application No. 08/881,278, filed on Jun. 24, 1997, now abandoned.
Application No. 08/881,278 is a continuation-in-part of application No. 08/610,455, filed on Mar. 4, 1996, now Pat. No. 5,835,264.

(30) Foreign Application Priority Data
Mar. 2, 1995 (DE) 195 07 344.4
Nov. 17, 1995 (DE) 195 42 827.7
Feb. 22, 1996 (DE) 196 06 424.4
Jun. 24, 1996 (DE) 196 25 200.8
May 30, 1997 (DE) 197 22 726.0

(51) Int. Cl. G02B 21/36

(52) U.S. Cl. 359/462; 359/368

(57) ABSTRACT

A method for generating a stereoscopic image of an object includes providing a microscope arrangement defining an imaging beam path coming from the object. The microscope arrangement includes an objective mounted in the beam path to define an intermediate image plane. A reflective element is placed in or close to the intermediate image plane or in or close to a plane conjugated to the intermediate image plane. The reflective element is driven at a clock frequency so as to reflect respective images of the object alternately toward the left and right eyes of an observer.

### RELATED APPLICATIONS

This is a continuation-in-part application of application Ser. No. 10/075,456, filed Feb. 15, 2002, which, in turn, is a continuation-in-part application of U.S. patent application Ser. No. 09/505,724, filed Feb. 17, 2000 (now U.S. Pat. No. 6,348,994), which, in turn, is a continuation application of U.S. patent application Ser. No. 08/881,278, filed Jun. 24, 1997 (now abandoned), which, in turn, is a continuation-in-part application of application Ser. No. 08/610,455, filed Mar. 4, 1996 (now U.S. Pat. No. 5,835,264). The present continuation-in-part application claims priority of German patent application nos. 195 07 344.4, filed Mar. 2, 1995; 195 42 827.7, filed Nov. 17, 1995; 196 06 424.4, filed Feb. 22, 1996; 196 25.200.8, filed Jun. 24, 1996; and, 197 22 726.0, filed May 30, 1997. The entire contents of all of the above German and United States patents and patent applications are incorporated herein by reference.

### BACKGROUND OF THE INVENTION

U.S. Pat. No. 5,835,264 discloses a method and an arrangement for generating a stereoscopic image in a microscope arrangement. An object is illuminated from two directions in a clocked manner and respective images are supplied to the right and left eye of the viewer at a clock frequency. For this purpose, the exit pupil of the objective is sectioned and alternately supplied to the left and right eye in a clocked manner above the flicker frequency of the eye.

Japanese patent publication JP 4-355 712 describes a stereoscopic viewing system wherein, in one embodiment, the splitting of the sectional images takes place by means of a rotating mirror system.

German patent publication 4,243,556 discloses a two channel stereoscopic microscope wherein the ocular images are supplied to a video camera in a clocked manner in order to realize a stereo illustration on a stereo-capable display.

British Patent 2,268,283 discloses how to generate stereoscopic images by means of a monocular instrument in that the beam path, which comes from an objective, is split utilizing mirrors or prisms and is supplied to two oculars or video cameras.

U.S. Pat. No. 5,333,902 discloses a stereoscopic endoscope wherein an image, which comes from an objective, is sectioned by means of a shutter and the sectional images are alternately shown on a stereo-capable display.

All of these solutions have in common that the light, which comes from the object, is not optimally utilized. This is so because a portion of the light is suppressed by diaphragms, splitters or shutters and therefore cannot contribute to forming the image.

### SUMMARY OF THE INVENTION

In view of the above, it is an object of the invention to provide an arrangement for generating a stereoscopic image wherein the resolution and the stereoscopic impression are significantly improved relative to the state of the art.

The method of the invention is for generating a stereoscopic image of an object and includes the steps of: providing a microscope arrangement defining an imaging beam path coming from the object with the microscope arrangement including an objective mounted in the beam path to define an intermediate image plane; placing a reflective element in or close to the intermediate image plane or in or close to a plane conjugated to the intermediate image plane; and, driving the reflective element at a clock frequency so as to reflect respective images of the object alternately toward the left and right eyes of an observer.

The stereoscopic image of a self-luminous object such as a microscopic fluorescent object is especially advantageously generated in that a switchable reflective element is mounted in the intermediate image plane downstream of the objective. The switchable reflective element alternately supplies an image of the object to the left and right eyes of the viewer in a clocked manner. The switching frequency lies above the flicker frequency of the eye and is, for example, 100 Hz or greater.

In this way, the sectioning of the exit pupil known from the state of the art with its light losses is replaced by an almost loss-free system. With this arrangement, transilluminated and incident-light illuminated objects can be viewed. The reflective element can be configured as a DMD mirror or a pivoted mirror. A DMD mirror or digital micromirror device comprises a plurality of micromirrors whose angular position can be electrostatically changed at a high switching speed.

### BRIEF DESCRIPTION OF THE DRAWINGS

The invention will now be explained with respect to the drawings wherein:

FIG. 1 is a schematic view of a stretched beam path in a microscope according to the invention;

FIGS. 2 and 3 are schematic views showing the optical elements;

FIG. 3a is a section view of the reflective element in the form of a mirror having a spherical surface; and,

FIGS. 4 and 5 show the rays of FIGS. 2 and 3, respectively.

### DESCRIPTION OF THE PREFERRED EMBODIMENTS OF THE INVENTION

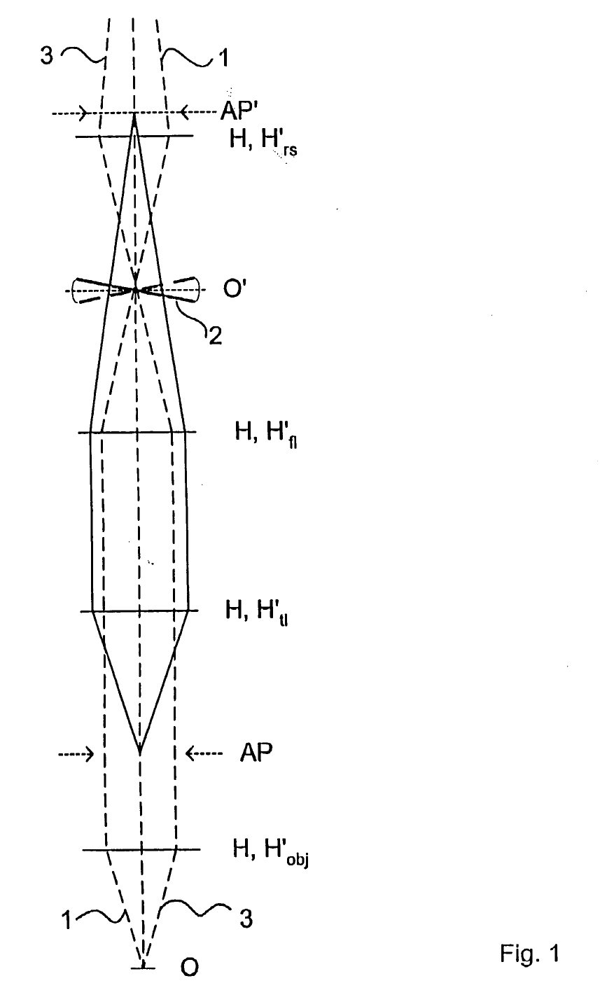

In FIG. 1, the light, which comes from an object 0, is imaged into the intermediate image plane O′ by an objective (main planes H, H′_{obj}), a tubular lens (main plane H, H′ₜₗ) and a field lens (main plane H, H′_{fl}). A reflective element 2 is mounted in the intermediate image plane O′ and has a reflection direction which can be varied or switched over. With this switchover of the reflective element 2, there is a change between an imaging of the object along ray 1 or ray 3 and therefore the object 0 is viewed from two directions so that a stereo impression is provided for the viewer.

To facilitate viewing the drawings, the additional beam path is shown stretched, that is, the direction change, which results after the reflection at reflective element 2, is neglected in order to continue the further beam path in the plane of the drawing. The further beam path includes a transmission optic (relay system) having the main plane (H, H′ᵣₛ) which effects the imaging into the oculars (not shown). AP and AP′ identify the exit pupil plane of the objective and the plane conjugated thereto, respectively. In known solutions for generating a stereo impression, a pupil sectioning takes place in plane AP′.

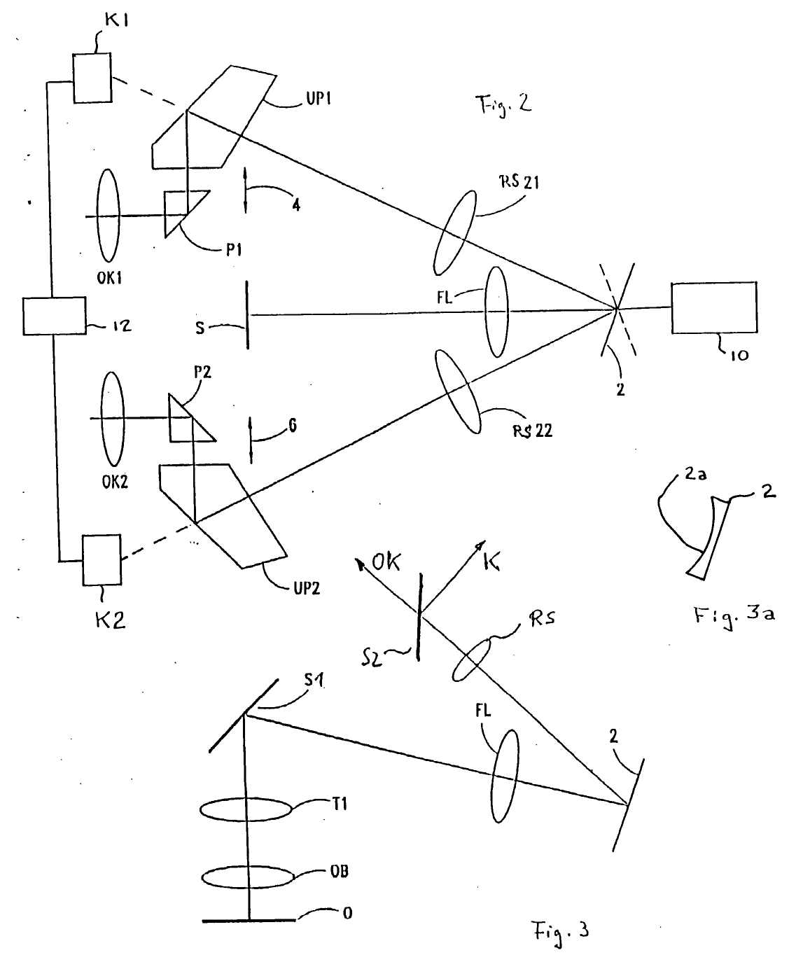

In FIGS. 2 and 3, the light of a self-luminous object 0 is taken up by the objective OB. A tubular lens T1 generates a first intermediate image on the far side of mirror S1. A field lens FL generates an image of the object 0 on a mirror 2. The mirror 2 images the beams in a clocked manner for a left ocular OK1 and a right ocular OK2 so that the centroid of the beam makes possible a stereo viewing and the aperture is maximally utilized. For this purpose, the mirror 2 can be configured as a pivoted or tilting mirror which oscillates back and forth between two angular deflections. The magnitude of the deflection determines the base width of the stereo image and is advantageously adjustable. According to another embodiment, the mirror 2 can have a spherical surface 2a as shown in FIG. 3a.

Alternatively, a DMD chip can be utilized as mirror 2 wherein the micromirrors are switched over at a clock frequency and virtually free of delay by a clock frequency generator 10. The relay lenses (RS21, RS22) of the transmitting system generate the intermediate images for the respective oculars (OK1, OK2). Deflecting prisms (UP1, UP2) and prisms (P1, P2) supply the intermediate image to the ocular viewing. By displacing the prisms (P1, P2), the eye spacing of the viewer can be adjusted which is indicated by reference numerals (4, 6).

Alternatively, or in common with the ocular viewing, the outcoupling of the image, which corresponds to the particular stereo channel, can take place also by means of mirror S2 onto electronic cameras (K1, K2) (see FIG. 2). With the help of the cameras (K1, K2), the stereo image can be viewed via known display techniques such as an image screen attachment and polarization spectacles. In FIG. 2, the electronic cameras (K1, K2) are connected to a 3D playback unit 12.

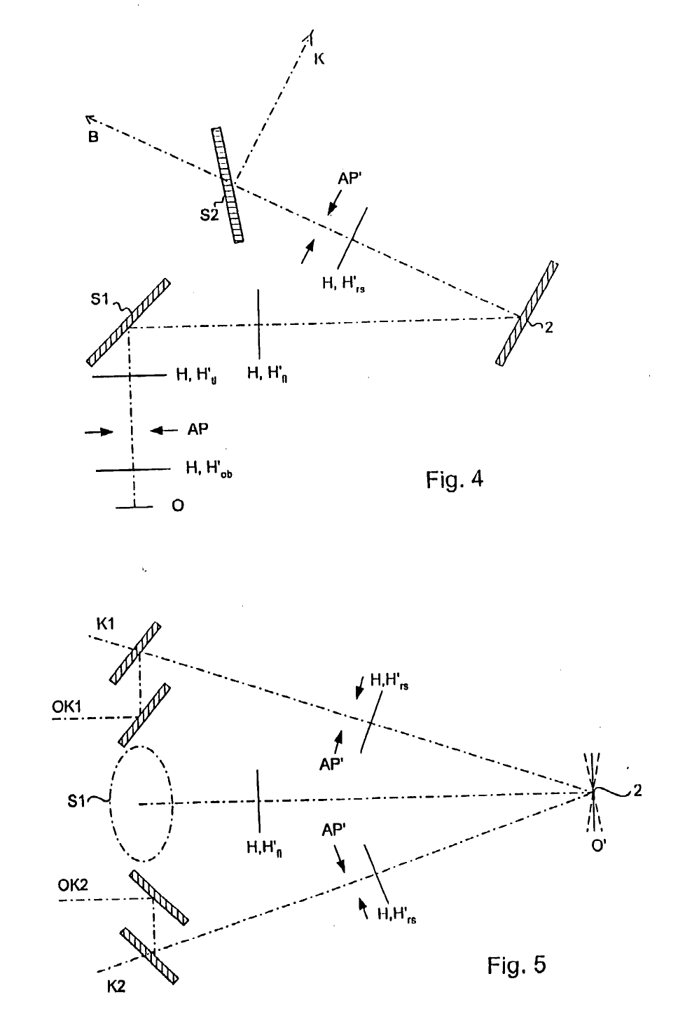

In FIGS. 4 and 5, the beam paths of FIGS. 2 and 3 are presented again. Here, the main planes (H, H′) of the individual optical assemblies are shown. FIG. 5 shows how the light, which comes from the object 0, is directed by the change of the orientation of the mirror 2 alternately to the two oculars OK1 and OK2. Depending upon the deflection of mirror 2, the imaging takes place along ray 1 or ray 3 (from FIG. 1) so that, in the oculars, always the image of the object arises from the direction belonging to ray 1 or ray 3.

The spatial separation of the two stereo channels can simultaneously be effected by the reflective element 2 for a correspondingly rapid switchover (especially when the element 2 is configured as a DMD). For this reason, the splitting utilizing shutters, diaphragms, polarizers or the like known from the state of the art and associated perforce with losses can be omitted. This leads to a significant increase of the brilliance and of the stereo impression.

For the case that a pivoted mirror is utilized as a reflective element and the switchover speed is limited for mechanical reasons, the separation of the stereo channels at the viewing end can also take place by means of shutters as described, for example, in U.S. Pat. No. 5,835,264 which is incorporated herein by reference.

As mentioned above and shown in FIG. 3a, the pivoted mirror can be configured to be spherical whereby, with a suitable shape, it is possible to include the imaging function of the transmission system RS and to thereby significantly simplify the system or eliminate the same entirely.

It is understood that the foregoing description is that of the preferred embodiments of the invention and that various changes and modifications may be made thereto without departing from the spirit and scope of the invention as defined in the appended claims.

1. A method for generating a stereoscopic image of an object, the method comprising the steps of:
providing a microscope arrangement defining an imaging beam path coming from said object with said microscope arrangement including an objective mounted in said beam path to define an intermediate image plane;
placing a reflective element in or close to said intermediate image plane or in or close to a plane conjugated to said intermediate image plane; and,
driving said reflective element at a clock frequency so as to reflect respective images of said object alternately toward the left and right eyes of an observer.

2. A microscope arrangement for generating a stereoscopic image of an object, the microscope arrangement defining an optical axis and comprising:
a microscope objective disposed on said axis and defining an intermediate image plane;
a reflective element disposed on said axis in or close to said intermediate image plane or a plane optically conjugated to said intermediate image plane; and,
means for switching said reflective element at a clock frequency so as to reflect respective images of said object alternately toward the left and right eyes of an observer.

3. The microscope arrangement of claim 2, further comprising right and left oculars for transmitting said images, respectively, to the left and right eyes of said observer.

4. The microscope arrangement of claim 2, further comprising a video camera and a 3-D playback unit connected downstream of said video camera for receiving said respective images at said clock frequency.

5. The microscope arrangement of claim 2, wherein said reflective element is a pivoted mirror unit.

6. The microscope arrangement of claim 2, wherein said reflective element is a DMD mirror.

7. The microscope arrangement of claim 2, wherein said reflective element has a spherical surface.
